(19) United States
(12) Patent Application Publication
(10) Pub. No.: US 2011/0043612 A1
(43) Pub. Date: Feb. 24, 2011

(54) DUAL-TUBE STEREOSCOPE

(75) Inventors: Kurtis Keller, Hillsborough, NC (US); Andrei State, Chapel Hill, NC (US)

Correspondence Address: KNOBBE MARTENS OLSON & BEAR LLP, 2040 MAIN STREET, FOURTEENTH FLOOR, IRVINE, CA, 92614, US

(73) Assignee: INNEROPTIC TECHNOLOGY INC., Hillsborough, NC (US)

(21) Appl. No.: 12/846,262

(22) Filed: Jul. 29, 2010

Related U.S. Application Data
(60) Provisional application No. 61/230,570, filed on Jul. 31, 2009.

(51) Int. Cl. H04N 13/02; G02B 6/42; G02B 6/26; G06K 9/40; H04N 13/04

(52) U.S. Cl. 348/49; 385/38; 385/27; 382/275; 348/51; 348/E13.074; 348/E13.075

(57) ABSTRACT

Presented herein are methods, systems, devices, and computer-readable media for dual-tube stereoscopes. Embodiments may include an elongated body comprising a proximal end and a distal end, the proximal end having at least one proximal opening, the distal end having first and second distal openings; a first waveguide coupled to the first distal opening; and a second waveguide coupled to the second distal opening. There may also be optics situated near the proximal end of the elongated body and configured to receive light from the first and second waveguides and to transmit the received light through the at least one proximal opening onto a single light-receiving device. Some embodiments include processing a single received digital image, comprising two sub-images, to produce two images viewable stereoscopically, for example.

### CROSS-REFERENCE TO RELATED APPLICATION

This application claims benefit of U.S. Provisional Application No. 61/230,570, filed Jul. 31, 2009, entitled Stereo Endoscope System, to Kurtis Keller et al, which is incorporated by reference herein for all purposes.

### FIELD OF THE INVENTION

The embodiments herein relate to scopes, such as endoscopes, borescopes, and microscopes. Embodiments relate more specifically to dual-tube stereoscopes.

### BACKGROUND

Endoscopes, borescopes, and microscopes typically provide a single path between an object and the imaging plane or the eye(s) of the viewer. An endoscope is an optical viewing device typically consisting of a rigid or flexible elongated body with an eyepiece at the proximal end, an objective lens at the distal end, and whose two ends are linked together by relay optics, fiber bundles, or other waveguides. Borescopes and microscopes are similarly constructed. The optical system can be surrounded by optical fibers or other light sources used for illumination of the remote object. An internal image of the illuminated object is formed by the objective lens and magnified by the eyepiece, which presents it to the viewer's eye.

Endoscopes are typically used to view the inside of the human body. There are numerous types of endoscopes, including: laparoscopes, endoscopes, fetoscopes, bronchoscopes, etc. Borescopes are used for inspection work, to view areas that are otherwise inaccessible, such as inside engines, industrial gas turbines, steam turbines, etc. Microscopes are typically used to view small objects in a magnified way.

Scopes that have a single optical path are limited in that they provide only a monoscopic view of the object being viewed. Further, previous methods of adding a second optical path to allow stereoscopic viewing have been cumbersome. These problems and others are addressed by the techniques, systems, methods, devices and computer-readable media described herein.

### SUMMARY

Presented herein are techniques, methods, systems, devices, and computer-readable media for dual-tube stereoscopes. In some embodiments, a scope may include an elongated body comprising a proximal end and a distal end, the proximal end having at least one proximal opening, the distal end having combined first and second distal openings; a first waveguide coupled to the first distal opening; and a second waveguide coupled to the second distal opening. There may also be optics situated near the proximal end of the elongated body and configured to receive light from the first and second waveguides and to transmit the received light through the at least one proximal opening onto a single light-receiving device.

Various techniques for producing dual images using a single camera and a dual-tube endoscope described herein may include, in various embodiments, receiving light through two distal lenses; transmitting the received light to two waveguides; transmitting light from the two waveguides onto a single light-receiving device as a single image containing two sub-images; and processing the single image to produce two images based at least in part on the two sub-images.

Some embodiments for processing dual-tube stereoscope images include receiving a single digital image from a single light-receiving device, the single digital image comprising two sub-images, the two sub-images having been received at the single light-receiving device from optics, which in turn received light from dual waveguides in a scope; and processing the single digital image in order to produce one output image for each of the two sub-images.

Numerous other embodiments are described throughout herein.

For purposes of summarizing the invention and the advantages achieved over the prior art, certain objects and advantages of the invention are described herein. Of course, it is to be understood that not necessarily all such objects or advantages need to be achieved in accordance with any particular embodiment. Thus, for example, those skilled in the art will recognize that the invention may be embodied or carried out in a manner that achieves or optimizes one advantage or group of advantages as taught or suggested herein, without necessarily achieving other objects or advantages as may be taught or suggested herein.

All of these embodiments are intended to be within the scope herein disclosed. These and other embodiments will become readily apparent to those skilled in the art from the following detailed description and from referring to the attached figures, the invention not being limited to any particular disclosed embodiment(s).

### BRIEF DESCRIPTION OF THE DRAWINGS

FIG. 1 illustrates a first dual-tube stereoscope.

FIG. 2 illustrates a second dual-tube stereoscope.

FIG. 3 illustrates a third dual-tube stereoscope.

FIG. 4 is a block diagram that illustrates a technique for dual-tube stereoscopy.

FIG. 5 illustrates a fourth dual-tube stereoscope.

FIG. 6 illustrates a fifth dual-tube stereoscope.

FIG. 7 illustrates a system for dual-tube stereoscopy.

FIG. 8A illustrates a first image related to dual-tube stereoscopy.

FIG. 8B illustrates a second image related to dual-tube stereoscopy.

FIG. 9A illustrates a first example scope mount.

FIG. 9B illustrates a second example scope mount.

### DETAILED DESCRIPTION

### Overview

Various embodiments herein provide for dual-tube stereo endoscopes. Consider an endoscope inside the body, taking images of a colon, for example. In order to view the colon stereoscopically, a left eye image and a right eye image must be produced. One approach would be to use two cameras at the ends of the endoscope, one of which would take a right eye view, while the other would take a left eye view. Together, these two images would enable stereoscopic viewing. A problem with this approach is that the resolution of these cameras, given that they must be very small, would be quite low. Further, when sterilizing the equipment, the camera and the endoscope would typically be put in an autoclave, and it is difficult to protect electronic equipment in the autoclave. Another approach would be to use two optical paths that connect the distal end of the endoscope to two cameras at the proximal end of the endoscope. An issue with this approach would be that the stereo endoscope's cameras would be bulky and heavy and therefore difficult to use.

As described herein, there is another approach: using a dual-tube scope and providing dual images on a single imager, such as those typically used with single-tube scopes. In some embodiments, the dual-tube stereoscopes are usable with a standard single-tube scope's mount, which has a single camera. The embodiments include dual, parallel optical paths which can each have a waveguide. As used herein, a ‘waveguide’ is a broad term and is intended to encompass its plain and ordinary meaning, including without limitation, any device or group of devices that can transmit light along a path or in a direction, such as relay optics, coherent fiber bundles, fiber optics, or other waveguides. The scope may also include fiber optics leading to the objective end, or lights mounted at the objective end, designed to illuminate the inside of the body or other objects being viewed with the scope. Light reflects off of objects and enters dual lenses at the distal end and passes through waveguides to the exit optics, which prepare the light for capture by a single light-receiving device. As used herein, a ‘light-receiving device’ is a broad term encompassing its plain and ordinary meaning, including without limitation, an apparatus for taking photos or video, such as any of the standard cameras used in current single-tube scopes. The resolution of the light-receiving device, such as a camera and its imager, can be a currently used resolution, for example, full high definition (“HD”) or “quarter HD.” For example, a five-millimeter scope may have a theoretical resolution limit somewhere under five hundred lines, and the standard HD imager or quarter-HD imager may be able to capture images above that resolution.

As noted above, exit optics may be used to transmit the dual images through the dual light paths and reproject them onto the single imager. There may be a single, shared-exit optical device (e.g., a lens or a group of lenses) or dual-exit devices (e.g., dual lenses or dual groups of lenses). A single-exit optical device may combine the two optical paths and reproject them onto the single camera, which has built-in optics to refocus on its imager(s). Dual-exit optics, one for each optical path, may also be used to focus and or project the light into the single camera. The optics used by the camera to focus the dual optical paths onto the imager may be any known optics, lens, or set of lenses, such as 20 mm, 24 mm, 28 mm, 35 mm optics or lenses and the like. In some embodiments, a scope's camera may have multiple individual imagers, each viewing a different color band of the full image, the different bands of light being separated by beam splitters or other such devices.

After the light from the dual-tube scope has been projected onto the camera's imager(s), processing may take place using a computer or other device to calibrate the images, correct for distortions, separate the two images, and the like. Once these dual images are received, they may be used to display a left-eye image and a right-eye image to an end user.

Additionally, more than two light paths may be used. For example, there may be four lenses at the distal end of the scope. Those four lenses may be attached to four waveguides and the four waveguides may transmit light to a single or to multiple optics at the proximal end of the scope. The optics at the proximal end of the scope may prepare the light for acquisition by a single camera. This single image with the four sub-images may then be processed by a computer or multiple computers, by a processor, or by multiple processors in order to produce four images that can be used to produce stereoscopic or depth information, for example.

### Examples of Dual-Tube Stereoscopes

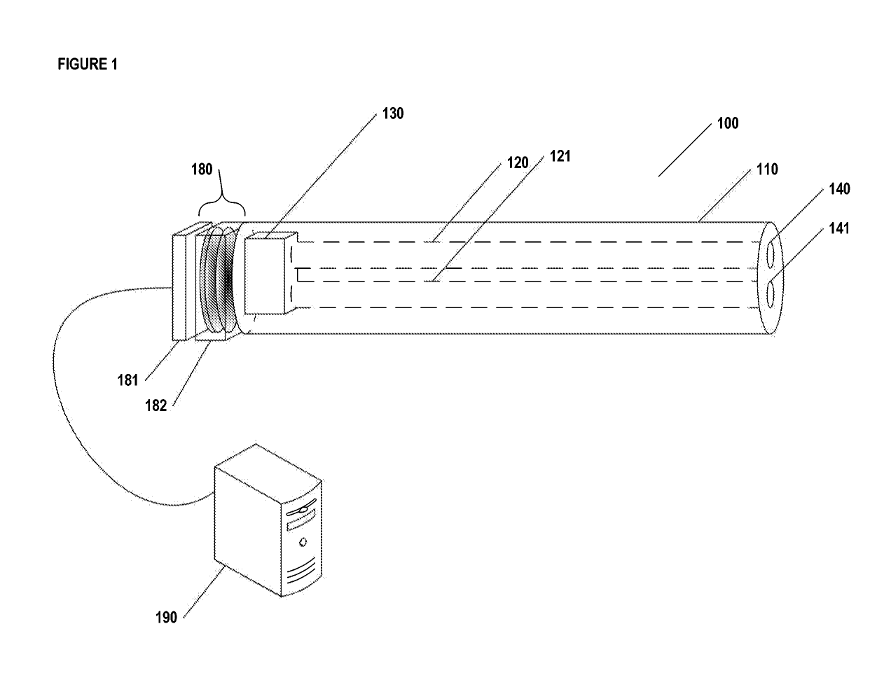

FIG. 1 illustrates a computer system 190 attached to a single light-receiving device 180. The light-receiving device 180 may be a camera, such as an HD camera, a quarter-HD camera, or any other appropriate device. The single light-receiving device 180 may include a single imager 181 and focusing optics 182. As noted above, the focusing optics 182 can include one or more lenses. The focusing optics 182 may include known optics, a lens, or set of lenses, such as 20 mm, 24 mm, 28 mm, or 35 mm optics. The focusing optics, in some embodiments, may capture the light from the scope 110 and project it onto an imager 182. Imager 182 may include anything capable of capturing an image, such as a charge-coupled device (“CCD”), a complementary metal-oxide-semiconductor (CMOS) device, etc. Optics 182 may be magnification optics 182, and, in some embodiments, magnification optics 182 may combine light from the light paths and project it as a single image (e.g., comprising dual sub-images) to the single camera 180. Further, in some embodiments, optics 182 may manipulate and/or adjust light from the scope to be directly eye-viewable by human users without the need for prisms.

A scope 110 is also part of the system 100. The scope 110 may include lenses 140 and 141 at the distal end of the scope 110, as well as waveguides 120 and 121 within the scope. As discussed above, the waveguides 120 and 121 may transmit light to optics 130. The optics 130 may prepare the light for transmission to the single camera 180. The light may pass through a single or multiple openings at the proximal end of the scope 110 (not illustrated in FIG. 1). In some embodiments, the waveguides 120 and 121 may be suspended inside the scope 110 with support structures, such as metal components. In some embodiments, the volume inside the scope 110 that is not occupied by the waveguides 120 and 121 may be filled with fiber bundles, fiber optics, etc, that may transmit light from the proximal end to the distal end of the scope 110. Further, the distal end of the scope 110 may be optically clear, translucent, or the like in order to allow transmission of the light through the fiber bundles to objects that could be viewed by a user of the scope.

### Single-Exit Optics

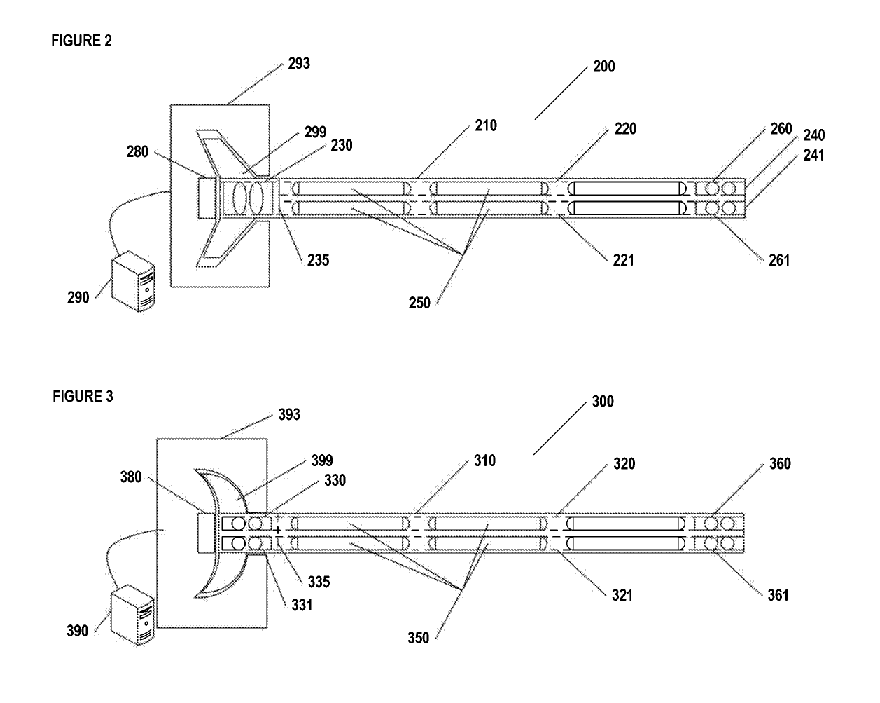

FIGS. 2 and 3 show two additional systems 200 and 300 that include scopes 210 and 310. Turning to FIG. 2, we see that a computer 290 is attached to a mount 293 that includes a single light-receiving device 280 and that the scope 210 has dual openings 240 and 241 at the distal end that are attached to entry optics 260 and 261. Entry optics 260 and 261 can include any standard optics or lenses usable with a scope and may have any appropriate field of view, such as 70 to 90 degrees. Further, in some embodiments, there may also be a prism, mirror, or other device at the distal end (not pictured) that allows the scope to be used to see to the side, at an angle, “rooftop” or top-down, or other views. These can be any appropriate angle, such as 15 to 30, 45, 90, etc. The distal lenses 260 and 261 transmit the received light through waveguides 220 and 221. As pictured in FIG. 2, waveguides 220 and 221 can include relay optics 250. In FIG. 2, scope 210 includes a field stop 235 and single-exit optics 230. The field stop 235 may be a reticle or anything else capable of limiting light passing through an optical path. There may be one field stop 235 for each waveguide 220 and 221, or there may be a single field stop device 235 with openings for each optical path. A field stop 235 may be part of a waveguide 220 or 221, coupled to a waveguide 220 or 221 or may be separate from the corresponding waveguide 220 or 221. The field stop 235 and exit optics 230 prepare the light received from the waveguides 220 and 221 for projection onto the single camera 280. In some embodiments, the images produced by exit optics 230 are directly viewable so that an operator looking at the proximal end of the scope would be able to see the images transmitted through the scope using the naked eye. Scope 210 may also include a scope mount 299 designed to couple to the mount 293 that includes the camera 280. In some embodiments, scope mount 299 will snap onto mount 293. In other embodiments, scope mount 299 will screw on, have attachments, or otherwise be capable of being tightened or locked in order to help prevent axial rotation of the camera 280 with respect to the scope 210. Examples of such mounts are those from Storz.

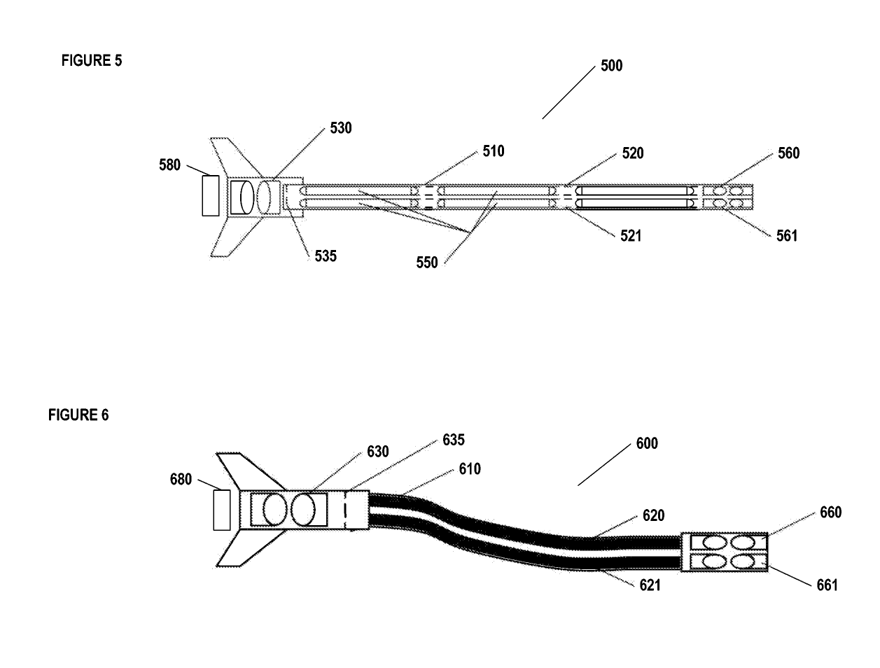

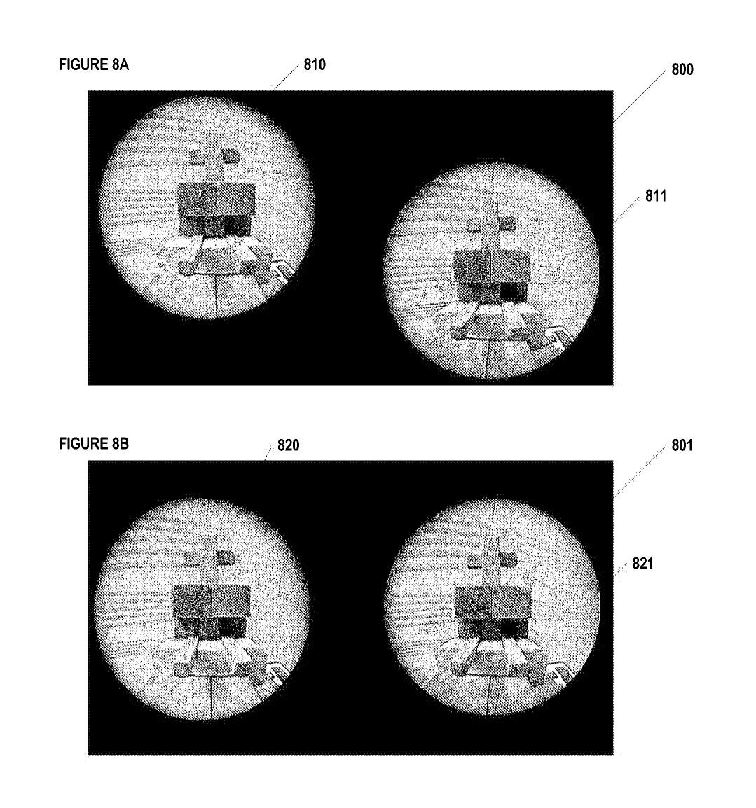

After light has been transmitted through optics 230 onto the single camera 280, the single image, with its two sub-images, is transmitted to computer system 290. At computer system 290, the two sub-images may be calibrated and/or otherwise corrected. In some embodiments, processing the two sub-images includes calibrating and/or (re-)aligning the two sub-images, if the scope has been bent or twisted, or is otherwise out of alignment. Consider FIGS. 8A and 8B. FIG. 8A depicts a first single image 800 that includes two sub-images 810 and 811. The two sub-images are not aligned. Processing the two sub-images 810 and 811 may include translating and/or rotating the sub-images 810 and 811 in order to properly align them, as depicted in FIG. 8B, which depicts an image 801 with two calibrated sub-images 820 and 821. In some embodiments, the use of field stops, such as field stop 235 may make the edges of sub-images 810 and 811 crisper, sharper, better-defined, or the like. This may allow automatic calibration and/or alignment to occur more easily. For example, if the edges of sub-images 810 and 811 are crisp, then it may be possible to easily detect the edges of the sub-images using, for example, thresholding and/or silhouetting methods, and to determine whether the sub-images are at the same pixel height in the captured single image, for example. In some embodiments, if the two sub-images 810 and 811 are not at the same pixel height, then they may be manipulated (e.g., shifted) in order to become aligned. As another example, when correcting for twisting or torsion of a scope, the crisp edges of each sub-image, as enhanced by use of reticle or field stops (e.g., field stop 535 in FIG. 5), allow the software to quickly detect a change in sub-image location on the full image and track and reposition the scope's calibration and/or distortion correcting map to this new position. Having crisp edges of sub-images 810 and 811 may also make it easier to detect the sub-images and their extents.

Processing the two sub-images may also include correcting for distortion in the two sub-images. The distortion may be caused by the optics in the scope including the distal lenses, the optical relays, and/or the exit optics. Correcting for distortion in images received through lenses can be performed by processes known in the art. Processing the two sub-images may also include zooming the images in or out, detection of zooming performed by camera or coupler, scaling the images to be larger or smaller, or the like. This may be useful, in some embodiments, when the zoom on a camera is not the desired zoom, for example.

After the two sub-images have been calibrated and corrected for distortion, the two sub-images can be separated. Separating the two sub-images into two images, in some embodiments, may include writing a portion of the corrected single image corresponding to the first sub-image into one portion of memory and writing the portion of the corrected single image corresponding to the second sub-image into another portion of memory. These two images, once processed and separated, can be shown to an operator as a dual image (e.g., image pair) or as a stereoscopic image. Displaying these two images as a stereoscopic image can allow an operator to view objects seen through the scope stereoscopically, “in 3D,”—almost as if the operator's eyes were observing from the end of the scope. In the case of an endoscope, for example, if the doctor using the endoscope is stereoscopically viewing images from inside the body, the appearance of the stereo images may be such that the doctor can perceive depth corresponding to the depth of the objects inside the body.

In some embodiments, the sub-images received through the distal lenses may be diffraction-limited or approximately diffraction-limited. For example, the sub-images received through the distal lenses transmitted through the two waveguides and through the optics onto a single camera may have a resolution lower than that of the single camera. In some embodiments, diffraction may limit the resolution of light that can be focused by standard optics. The equation or calculation usable to determine the diffraction limit using standard spherical ground optics may be:

Sin(θ)=1.22*λ/D

Where
θ=Resolving angle
λ=Central wavelength
D=Entrance pupil diameter
   Further, in some embodiments, the single camera may have more than N times the resolution of the approximately diffraction-limited images passing through the waveguides, where N equals the number of optical paths. For example, in some embodiments, the single camera may have more than twice the resolution so that it may receive images from two light paths (e.g., through two distal lenses to waveguides and associated exit optics). In this respect, in some embodiments, the resolution captured through the scope may be maintained even though a single camera or other light-receiving device is used.

### Dual-Exit Optics

FIG. 3 shows a system 300 including a scope 310 with dual-exit optics 330 and 331. The scope 310 includes dual distal lenses 360 and 361, which can transmit light through dual waveguides 320 and 321, through relay optics 350, and through field stop 335 to the dual exit optics 330 and 331. The scope 310 also includes an optional scope mount 399 designed to couple to mount 393, which contains single camera 380. Light received through the distal lenses 360 and 361, transmitted through the two waveguides 320 and 321, and transmitted through the dual-exit optics 330 and 331 may produce a single image on the single camera 380. That single image produced on camera 380 may include two sub-images corresponding to the light received in each of the dual distal lenses 360 and 361. That single image may be sent to computer 390 and the single image with the two sub-images may be processed in a manner similar to that described with respect to FIG. 2. Further, in embodiments with dual-exit optics 330 and 331, an operator may be able to see dual images. The dual images may be used to produce a stereoscopic effect for an operator.

### Methods for Dual-Tube Stereoscopes

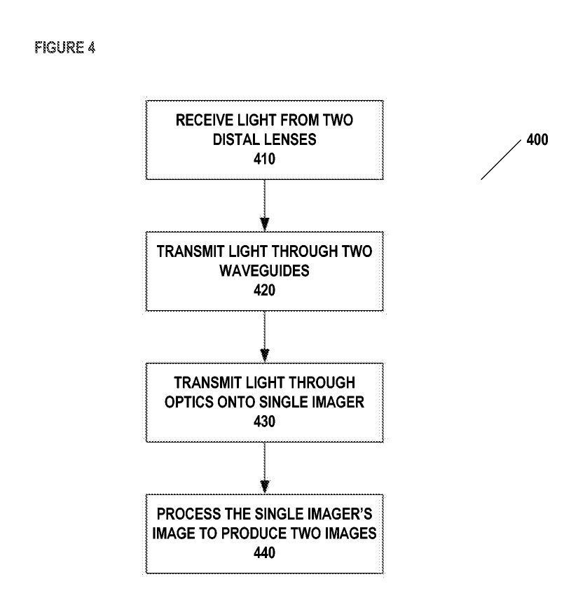

FIG. 4 depicts a method 400 of processing received light for dual tube stereoscopes. In block 410, light is received through dual distal lenses. This is described above. In block 420, the light received through the dual distal lenses is transmitted through the waveguides. As described with respect to FIGS. 2 and 3, the waveguides may include relay optics. As depicted in FIG. 6, the waveguides may also include coherent fiber bundles or fiber optics 620 and 621. Whether coherent fiber bundles, fiber optics, relay optics, or other types of waveguides are used, the light received from the dual distal lenses is passed through the two waveguides in block 420 and transmitted through optics to a single camera in block 430. The light may also optionally pass through a field stop before being transmitted to the single camera.

As described above with respect to FIGS. 2 and 3, the optics may be at the proximal end of the scope and may include a single optical device for capturing and transmitting light from multiple waveguides, or may include multiple optical devices (e.g., one for each waveguide). Regardless of the number and type of optics used, the optics transmits the light to a single camera in block 430.

In block 440, the single camera's image is processed to produce two images, one of each of which is associated with the light path from the two distal lenses. Processing the single camera's image (with its two sub-images) to produce two separate images may include calibrating and/or aligning the image and correcting distortion in the image in order to produce two images. This is described elsewhere herein and an example is shown in FIGS. 8A and 8B. Calibrating and/or aligning the two sub-images may include rotating the sub-images or translating the sub-images. Images that have passed through field stops may have sharper, crisper, or otherwise more detectable edges. In some embodiments, images with sharper, crisper, or otherwise more detectable edges may be easier to calibrate. In some embodiments, calibrating the two sub-images also comprises skewing one or both of the two images. When, as described above, there are more than two tubes in the scope (and more than two corresponding paths through which light travels to the single camera) each of the sub-images may be calibrated separately, or all of them may be calibrated in a similar manner. Block 440 may also include up-sampling of down-sampling the received image or sub-images, for example in order to compensate for the zoom of a lens or to compensate for the diffraction-limited or approximately diffraction-limited resolution.

The blocks of method 400 may be performed in a different order, additional blocks may be performed as part of the method, and/or blocks may be omitted from the method.

### More Embodiments of Dual-Tube Stereoscopes

FIG. 5 illustrates a system 500 including a dual-tube stereoscope 510. The dual-tube stereoscope 510 includes dual distal lenses 560 and 561, dual waveguides 520 and 521, which include relay optics 550, field stop 535, and a single lens for the exit optics 530. As illustrated in FIG. 5, the body of the dual-tube scope may be thinner than the exit optics 530. In this respect, a thin scope may be used with a larger mount and/or may produce images on a larger single light-receiving device 580 than might otherwise be possible.

FIG. 6 illustrates a system 600 including a dual-tube stereoscope 610 that includes dual distal lenses 660 and 661, dual waveguides 620 and 621, field stop 635, and exit optics 630, which includes, for example, a single lens. The dual waveguides 620 and 621 may be fiber optics or coherent fiber bundles that transmit light received from dual distal lenses 660 and 661, through the field stop 635, to the exit optics 630, and eventually a single image with two sub-images is captured by the single light-receiving device 680. As above, the single light-receiving device 680 may receive a single image with two sub-images that may later be processed for viewing as two separate images or to produce a stereoscopic image.

Dual-tube stereoscopes may be used to produce dual images, stereoscopic images, or may be used to extract or reconstruct depth from a scene in order to produce 3D models. In some embodiments, the dual-tube stereoscope may be an endoscope, such as a laparoscope, enteroscope, colonoscope, sigmoidoscope, rectoscope, anoscope, proctoscope, rhinoscope, bronchoscope, otoscope, cystoscope, gynoscope, colposcope, hysteroscope, falloposcope, arthoscope, thoracoscope, mediastinoscope, amnioscope, fetoscope, laryngoscope, esophagoscope, bronchoscope, epiduroscope, and other types of surgical or medical scopes. Non-medical scopes are also embodiments of scopes discussed herein, such as architectural endoscopes, which may be used for planning in architectural and pre-visualization of scale models. Additionally, embodiments of the scopes herein may be borescopes, which may be used for internal inspection of complex technical systems, for example. Additional scopes may include, in various embodiments, microscopes.

### Systems for Dual-Tube Stereoscopes

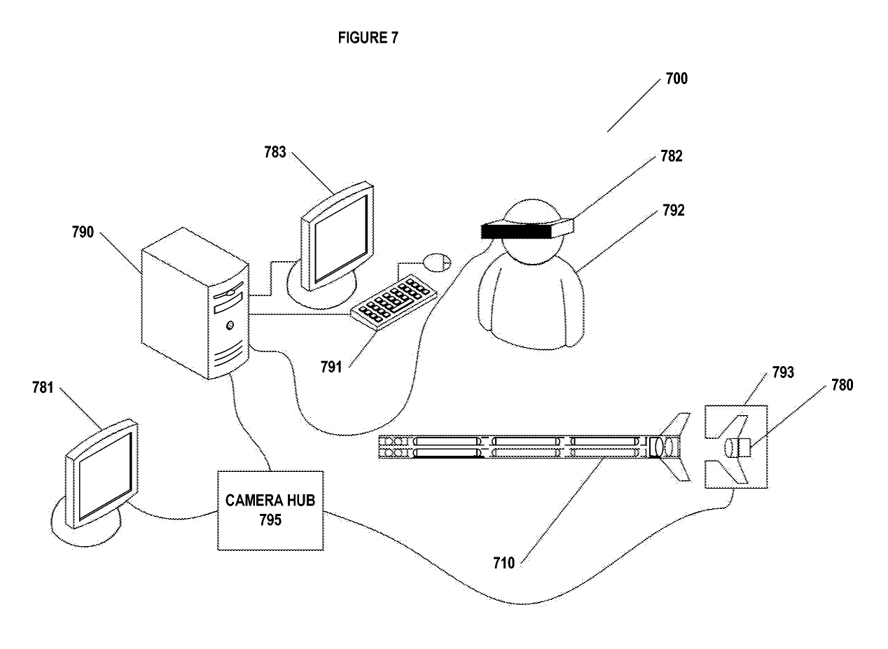

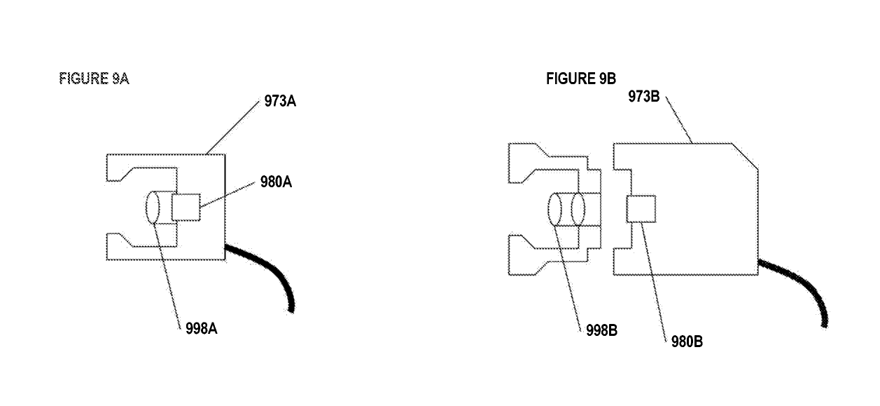

As depicted in FIG. 7, an operator 792 may be able to manipulate a scope 710 that may be placed in a mount 793 that includes camera 780. The mount may also include an optical coupler for coupling the camera 780 to the scope 710. For example, as depicted in FIGS. 9A and 9B, a mount for a scope, such as an endoscope, borescope, etc, may have a camera 980A and an optical coupler 998A integrated into the mount 973A. In some embodiments, the optical coupler 998B for the scope may be separable from and attachable to another portion of the camera system 973B that includes the camera 980B.

The camera 780 may include a single imager that would traditionally receive a single image corresponding to a single optical path, but instead receives a single image containing two sub-images from the scope 710. As discussed above, the two sub-images on the single image may later be used for stereoscopic presentation, or to display a dual image from the scope. A mount 793 may be connected or coupled to a camera hub 795. The camera hub 795 may transmit the single image to a stereoscopic or monoscopic monitor 781 and the dual images may be displayed as raw data or may first be processed by computer system 790 and returned to the camera hub 795 for production of a dual image or stereoscopic image on monitor 781. Camera hub 795 may also transmit the images to computer system 790. The computer system 790 may then produce the two images from the two sub-images contained within the single received image captured by the scope 710. The two images may be displayed together (e.g., side by side) on monitor 783 or stereoscopically on monitor 783. Operator 792 may also be wearing a head-mounted display 782 or 3D viewing glasses 782. Multiple stereoscopic monitors 783 may present multiple copies of the stereoscopic images simultaneously for multiple viewers. The computer system 790 may also be equipped with a digital recorder or other device that records the video stream being presented at one or more of the displays 781, 782, and/or 783. For example, a program such as “Fraps” or other stereo recording software may be used or integrated into the computer 790 to record calibrated, aligned, distortion-corrected stereoscopic output.

In embodiments where the operator 792 is wearing 3D viewing glasses 782, the operator may view monitor 781 or 783 in order to see a stereoscopic image of the objects, or images captured by scope 710. In embodiments where an operator 792 is wearing a head-mounted display 782, two sub-images captured by the scope 710 and transmitted from the mount 793 to the camera hub 795, may be processed by the computer 790 in order to produce dual images to be shown to the left and right eye of the operator 792 by means of the head-mounted display 782. The operator may also manipulate or otherwise interact with the images and/or the computer system 790 using input devices 791, such as a mouse and/or keyboard.

### Kits for Dual-Tube Stereoscopes

Some embodiments include kits for use with or containing some or all of the parts for a dual-tube stereoscope. For example, one or more parts of a dual-tube stereoscope may be disposable and those disposable parts may come in a kit, such as a sterile bag. For example, if a sheath attachable to the distal end of the scope were removable and disposable, then a kit for the dual-tube stereoscope may include the sheath.

The processes and systems described herein may be performed on or encompass various types of hardware, such as computer systems. In some embodiments, computer 790, displays 781, 782, and 783, camera hub 795, and/or input device 791 may each be separate computer systems, applications, or processes, or may run as part of the same computer systems, applications, or processes—or one of more may be combined to run as part of one application or process—and/or each or one or more may be part of or run on a computer system. A computer system may include a bus or other communication mechanism for communicating information, and a processor coupled with the bus for processing information. The computer systems may have a main memory, such as a random access memory or other dynamic storage device, coupled to the bus. The main memory may be used to store instructions and temporary variables. The computer systems may also include a read-only memory or other static storage device coupled to the bus for storing static information and instructions. The computer systems may also be coupled to a display, such as a CRT or LCD monitor. Input devices may also be coupled to the computer system. These input devices may include a mouse, a trackball, keyboard, joystick, touch screen, or cursor direction keys.

Each computer system may be implemented using one or more physical computers or computer systems, or portions thereof. The instructions executed by the computer system may also be read in from a computer-readable storage medium. The computer-readable storage medium may be a CD, DVD, optical or magnetic disk, laserdisc, carrier wave, or any other medium that is readable by the computer system. In some embodiments, hardwired circuitry may be used in place of or in combination with software instructions executed by the processor. Communication among modules, systems, devices, and elements may be over direct or switched connections, and wired or wireless networks or connections, via directly connected wires, or via any other appropriate communication mechanism. The communication among modules, systems, devices, and elements may include handshaking, notifications, coordination, encapsulation, encryption, headers, such as routing or error detecting headers, or any other appropriate communication protocol or attribute. Communication may also make use of messages related to HTTP, HTTPS, FTP, TCP, IP, ebMS OASIS/ebXML, secure sockets, VPN, encrypted or unencrypted pipes, MIME, SMTP, MIME Multipart/Related Content-type, SQL, etc.

The 3D graphics may be produced using two or more captured images and/or based on underlying data models and projected onto one or more 2D planes in order to create left and right eye images for a head mount, lenticular, or other 3D display. Any appropriate 3D graphics processing may be used for displaying or rendering, including processing based on OpenGL, Direct3D, Java 3D, etc. Whole, partial, or modified 3D graphics packages may also be used, such packages including 3DS Max, SolidWorks, Maya, Form Z, Cybermotion 3D, or any others. In some embodiments, various parts of the needed rendering may occur on traditional or specialized graphics hardware. The rendering may also occur on the general-purpose CPU, on programmable hardware, on a separate processor, be distributed over multiple processors, over multiple dedicated graphics cards, or may use any other appropriate combination of hardware or technique.

In some embodiments, displays 781, 782, and/or 783 present stereoscopic 3D images to an operator, such as a physician. Stereoscopic 3D displays deliver separate imagery to each of the user's eyes. This can be accomplished by a passive stereoscopic display, an active frame-sequential stereoscopic display, a lenticular auto-stereoscopic display, or any other appropriate type of display. The displays 781, 782, and/or 783 may be passive alternating-row or alternating-column displays. Example of polarization-based alternating-row displays include the Miracube G240S, as well as Zalman Trimon Monitors. Alternating-column displays include devices manufactured by Sharp, as well as many “auto-stereoscopic” displays (e.g. by Philips). Displays 781, 782, and/or 783 may also be cathode ray tubes (CRTs). CRT-based devices, may use temporal sequencing, showing imagery for the left and right eye in temporal sequential alternation; this method may also be used by newer, projection-based devices, as well as by rapidly switchable (e.g., 120 Hz) liquid crystal display (LCD) devices. In some embodiments, a user may wear a head-mounted display 782 in order to receive 3D images from the computer system 790. In such embodiments, a separate display, such as the pictured displays 781 and/or 783, may be omitted.

As will be apparent, the features and attributes of the specific embodiments disclosed above may be combined in different ways to form additional embodiments, all of which fall within the scope of the present disclosure.

Depending on the embodiment, certain acts, events, or functions of any of the algorithms described herein can be performed in a different sequence, can be added, merged, or left out all together (e.g., not all described acts or events are necessary for the practice of the algorithms). Moreover, in certain embodiments, acts or events can be performed concurrently rather than sequentially, e.g., through multi-threaded processing, interrupt processing, or multiple processors or processor cores, or on other parallel architectures.

The various illustrative logical blocks, modules, and algorithm steps described in connection with the embodiments disclosed herein can be implemented as electronic hardware, as computer software, or as combinations of both. To clearly illustrate this interchangeability of hardware and software, various illustrative components, blocks, modules, and steps have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

The various illustrative logical blocks and modules described in connection with the embodiments disclosed herein can be implemented or performed by a machine or computing device. Here the term ‘computing device’ includes its plain and ordinary meaning, including, but not limited to any machine, hardware, or other device capable of performing calculations or operations automatically, such as a general-purpose processor, a digital signal processor (DSP), an application-specific integrated circuit (ASIC), a field-programmable gate array (FPGA) or other programmable logic device, discrete gate or transistor logic, discrete hardware components, or any combination thereof designed to perform the functions described herein. A general-purpose processor can be a microprocessor, a controller, microcontroller, or state machine, combinations of the same, or the like. A processor can also be implemented as a combination of computing devices, e.g., a combination of a DSP and a microprocessor, a plurality of microprocessors, one or more microprocessors in conjunction with a DSP core, or any other such configuration.

The steps of a method, process, or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM or other optical media, or any other form of computer-readable storage medium known in the art. An exemplary storage medium can be coupled to the processor such that the processor can read information from, and write information to, the storage medium. In some embodiments, the storage medium can be integral to the processor. The processor and the storage medium can reside in an ASIC. The ASIC can optionally reside in a user terminal. In some embodiments, the processor and the storage medium can reside as discrete components in a user terminal.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

Any process descriptions, elements, or blocks in the flow diagrams described herein and/or depicted in the attached figures should be understood as potentially representing modules, segments, or portions of code which include one or more executable instructions for implementing specific logical functions or steps in the process. Alternate implementations are included within the scope of the embodiments described herein, in which elements or functions may be deleted, executed out of order from that shown or discussed, including substantially concurrently or in reverse order, depending on the functionality involved, as would be understood by those skilled in the art.

All of the methods and processes described above may be embodied in, and fully automated via, software code modules executed by one or more general-purpose computers or processors, such as those computer systems described above. The code modules may be stored in any type of computer-readable medium or other computer storage device. Some or all of the methods may alternatively be embodied in specialized computer hardware.

It should be emphasized that many variations and modifications may be made to the above-described embodiments, the elements of which are to be understood as being among other acceptable examples. All such modifications and variations are intended to be included herein within the scope of this disclosure and protected by the following claims.

The following patents and publications are incorporated by reference herein in their entireties for all purposes: U.S. Pat. No. 6,898,022, U.S. Pat. No. 6,614,595, U.S. Pat. No. 6,450,950, U.S. Pat. No. 6,104,426, U.S. Pat. No. 5,776,049, U.S. Pat. No. 5,673,147 U.S. Pat. No. 5,603,687, U.S. Pat. No. 5,527,263, U.S. Pat. No. 5,522,789, U.S. Pat. No. 5,385,138, U.S. Pat. No. 5,222,477, U.S. Pat. No. 5,191,203, U.S. Pat. No. 5,122,650, U.S. Pat. No. 4,862,873, U.S. Pat. No. 4,873,572, U.S. Pat. No. 7,277,120, and U.S. Pub. No. 2008/0151041.

What is claimed is:

1. A system for capturing images, comprising:
an elongated body comprising:
a proximal end and a distal end, the proximal end having at least one proximal opening, the distal end having first and second distal openings;
a first waveguide coupled to the first distal opening; and
a second waveguide coupled to the second distal opening; and
optics situated near the proximal end of the elongated body and configured to receive light from the first and second waveguides and to transmit the received light onto a single light-receiving device.

2. The system of claim 1, wherein, when light is passed through the first and second distal openings, said light is transmitted through the first and second waveguides, through the optics, and through the at least one proximal opening, to produce two sub-images.

3. The system of claim 2, wherein the two sub-images are directly eye-viewable.

4. The system of claim 2, wherein the system further comprises one or more computing devices configured to process the two sub-images.

5. The system of claim 4, wherein the one or more processors are configured to remove distortions in the two sub-images.

6. The system of claim 4, wherein the one or more processors are configured to calibrate or align the two sub-images.

7. The system of claim 1, wherein the single light-receiving device is a camera.

8. The system of claim 1, wherein the single light-receiving device is a high-definition camera.

9. The system of claim 1, wherein the elongated body and optics, in combination, produce two approximately diffraction-limited resolution sub-images.

10. The system of claim 9, wherein a resolution of the single light-receiving device is higher than needed to capture the two approximately diffraction-limited resolution sub-images.

11. The system of claim 1, wherein said optics comprise a shared optical element that combines the light received from the first and second waveguides and produces the two sub-images on the single light-receiving device.

12. The system of claim 1, wherein said optics comprise two or more optical elements that transmit the light received from the first and second waveguides to the single light-receiving device.

13. The system of claim 1, wherein said optics are situated inside said elongated body.

14. The system of claim 1, wherein the system further comprises entry optics coupled to the distal end to provide for capturing light at an angle at the distal end.

15. The system of claim 1, wherein the system further comprises a first field stop positioned within a first optical path associated with the first waveguide and a second field stop positioned within a second optical path associated with the second waveguide.

16. A method for producing dual images using a single light-receiving device and a dual-tube stereoscope, comprising:
receiving light through two distal lenses;
transmitting the received light to two waveguides;
transmitting light from the two waveguides onto a single light-receiving device as a single image containing two sub-images; and
processing the single image to produce two images based at least in part on the two sub-images.

17. The method of claim 16, wherein the method further comprises displaying the two produced images stereoscopically to an operator of the dual-tube stereoscope.

18. The method of claim 16, wherein processing the single digital image comprises calibrating or aligning the two sub-images.

19. The method of claim 18, wherein the method further comprises transmitting the light through two field stops, and wherein the two sub-images that have been produced, at least in part, are based on the light passed through the two field stops.

20. The method of claim 16, wherein the method further comprises recording monoscopic or stereoscopic video of the two images produced based at least in part on the two sub-images.

21. A system for processing dual-tube stereoscope images, comprising:
an image receiver configured to receive a single digital image from a single light-receiving device, the single digital image comprising two sub-images, the two sub-images having been received at the single light-receiving device from optics, which in turn received light from dual waveguides in a scope; and
one or more computing devices configured to process the single digital image in order to produce one resulting image for each of the two sub-images.

22. The system of claim 21, wherein processing the single digital image comprises removing distortions in the two sub-images.

23. The system of claim 21, wherein processing the single digital image comprises calibrating the two sub-images.

24. A method for processing dual-tube stereoscope images, comprising:
receiving a single digital image from a single light-receiving device, the single digital image comprising two sub-images, the two sub-images having been received at the single light-receiving device from optics, which in turn received light from dual waveguides in a scope; and
processing the single digital image in order to produce one resulting image for each of the two sub-images.

25. The method of claim 24, wherein processing the single digital image comprises calibrating the two sub-images.

26. The method of claim 16, wherein the method further comprises displaying the two resulting images stereoscopically to an operator of the dual-tube stereoscope.
